(19) United States
(12) Patent Application Publication
(10) Pub. No.: US 2016/0220967 A1
(43) Pub. Date: Aug. 4, 2016

(54) OXYGEN ENRICHMENT MEMBRANE AND METHOD FOR PRODUCING SAME

(71) Applicant: TOYO TIRE & RUBBER CO., LTD., Osaka (JP)

(72) Inventor: Tomohiko Kurahashi, Osaka-shi (JP)

(73) Assignee: TOYO TIRE & RUBBER CO., LTD., Osaka (JP)

(21) Appl. No.: 15/012,042

(22) Filed: Feb. 1, 2016

(30) Foreign Application Priority Data
Feb. 3, 2015 (JP) 2015-019291

(51) Int. Cl. B01D 71/70; B01D 53/22; B01D 67/00; B01D 69/02; B01D 69/12

(52) U.S. Cl. CPC B01D 71/70; B01D 69/02; B01D 69/125; B01D 67/0006; B01D 53/228; B01D 2323/40; B01D 2323/12; B01D 2323/36

(57) ABSTRACT

Provided is an oxygen enrichment membrane that has both good oxygen separation performance and good membrane physical properties (mechanical strength, ease of membrane formation, etc.), and moreover, can be used to industrially obtain a high concentration of oxygen, and a method for producing the oxygen enrichment membrane. The oxygen enrichment membrane includes, as a main component, a hydrocarbon group-containing polysiloxane network structure material which is a reaction product of a tetraalkoxysilane and a hydrocarbon group-containing dialkoxysilane. The tetraalkoxysilane is a tetramethoxysilane or a tetraethoxysilane (referred to as “A”), and the hydrocarbon group-containing dialkoxysilane is dimethyldimethoxysilane or diethyldiethoxysilane (referred to as “B”). The mixing ratio (A/B) of the A and the B as expressed in a molar ratio is 1/9-9/1.

### CROSS-REFERENCE TO RELATED APPLICATION

This application claims priority to Japanese Patent Application No. 2015-019291 filed on Feb. 3, 2015, the entire disclosure of which is incorporated by reference herein.

### BACKGROUND

The present disclosure relates to oxygen enrichment membranes for selectively separating oxygen from oxygen-containing gas, such as air and the like, and methods for producing an oxygen enrichment membrane.

A variety of technologies are being developed for obtaining a high concentration of oxygen in the fields of industry, medicine, food, and the like. Oxygen constitutes about 20% of air. If oxygen can be selectively separated from air, it is possible to efficiently obtain a large amount of oxygen without the need of techniques such as electrolysis of water, which consumes a great deal of energy, and the like. To this end, in the background art, oxygen enrichment membranes for separating oxygen from air and thereby enriching oxygen have been researched and developed.

For example, an oxygen gas separation membrane formed from a cross-linked mixture of polydimethylsiloxane and polydiphenylsiloxane has been developed (e.g., see Japanese Unexamined Patent Application Publication No. H05-111626). The cross-linking bond between polydimethylsiloxane and polydiphenylsiloxane imparts improved heat resistance and mechanical properties to the oxygen gas separation membrane of Japanese Unexamined Patent Application Publication No. H05-111626.

Alternatively, porous silica that is produced by a sol-gel reaction of a silane alkoxide(s) has been used as a gas separation membrane (e.g., see Japanese Unexamined Patent Application Publication No. 2001-276586). The gas separation membrane of Japanese Unexamined Patent Application Publication No. 2001-276586 is produced by performing: (a) formulating a precursor sol by hydrolysis of a silane alkoxide(s); (b) forming an amorphous oxide membrane having a plurality of pores formed by cyclic siloxane linkages by applying the precursor sol on a surface of a porous support member, followed by drying and baking; (c) causing water to be adsorbed into the pores of the oxide membrane; and (d) drying the oxide membrane at a temperature lower than the baking temperature.

Moreover, a highly oxygen permeable plastic material is known that is produced by molding a gel that is obtained by polymerization of a dialkoxydialkylsilane in a sol of a thermoplastic polymer (e.g., see Japanese Unexamined Patent Application Publication No. 2009-280743). In the highly oxygen permeable plastic material of Japanese Unexamined Patent Application Publication No. 2009-280743, a nano-sized linear polysiloxane generated by polymerization of the dialkoxydialkylsilane is dispersed in the thermoplastic polymer, which provides formability and flexibility that allow the material to be processed into a soft contact lens or the like.

In order to efficiently separate oxygen from air using a gas separation membrane, it is necessary to develop a material having high affinity for oxygen and low affinity for nitrogen, or a material having high affinity for nitrogen and low affinity for oxygen. Also, in order to allow for practical use of a gas separation membrane, it is necessary to take into consideration a balance between gas separation performance and physical properties (mechanical strength, ease of membrane formation, etc.) possessed by the membrane itself. Here, gas separation membranes generally contain a porous material that contains metal oxides such as a polysiloxane and the like as a main ingredient. The properties and performance of the gas separation membrane significantly vary depending on the combination of metal oxide materials. Therefore, for the development of an oxygen enrichment membrane, it is important to formulate a variety of combinations of metal oxide materials through a certain trial and error and thereby find an optimum combination.

In this regard, for the oxygen gas separation membrane of Japanese Unexamined Patent Application Publication No. H05-111626, polydimethylsiloxane is produced by polycondensation of octamethylcyclotetrasiloxane, and polydiphenylsiloxane is produced by polymerization of octaphenylcyclotetrasiloxane. Moreover, the polydimethylsiloxane and polydiphenylsiloxane thus produced are dissolved and mixed in benzene, and are cross-linked by addition of benzoyl peroxide to the mixture. These multiple reaction steps make it difficult to consistently form metal oxides having a constant composition, and therefore, it is considered that it is difficult to industrially produce the separation membrane. Also, the separation performance of oxygen and nitrogen described in examples of Japanese Unexamined Patent Application Publication No. H05-111626 cannot be said to be sufficient.

The gas separation membrane of Japanese Unexamined Patent Application Publication No. 2001-276586 is produced using a sol-gel reaction of a silane alkoxide(s). According to examples of Japanese Unexamined Patent Application Publication No. 2001-276586, a tetraalkoxysilane and phenyltriethoxysilane are mainly used as materials. In other words, a tetrafunctional alkoxysilane and a trifunctional alkoxysilane are used. However, the combination of a tetrafunctional alkoxysilane and a trifunctional alkoxysilane cannot be said to necessarily provide sufficient oxygen separation performance, and therefore, there is room for improvement.

The highly oxygen permeable plastic material of Japanese Unexamined Patent Application Publication No. 2009-280743 is produced by a combination of a vinyl polymer which is a thermoplastic polymer and a linear polysiloxane which is obtained from a dialkoxydialkylsilane. As can be seen from the use of the material for a soft contact lens, the material leads to a very soft membrane, and therefore, is not suitable for an industrial-use oxygen enrichment membrane.

### SUMMARY

The present disclosure describes implementations of an oxygen enrichment membrane that has both good oxygen separation performance and good membrane physical properties (mechanical strength, ease of membrane formation, etc.), and moreover, that can be used to industrially obtain a high concentration of oxygen, and a method for producing the oxygen enrichment membrane.

An example oxygen enrichment membrane according to the present disclosure includes, as a main component, a hydrocarbon group-containing polysiloxane network structure material which is a reaction product of a tetraalkoxysilane and a hydrocarbon group-containing dialkoxysilane.

According to the example oxygen enrichment membrane having the above constitution, a hydrocarbon group-containing polysiloxane network structure material which is a reaction product of a tetraalkoxysilane and a hydrocarbon group-containing dialkoxysilane is used as a main component, whereby an industrially applicable oxygen enrichment membrane having both good oxygen separation performance derived from the hydrocarbon group-containing dialkoxysilane and rigidity derived from the tetraalkoxysilane can be achieved.

In the above example oxygen enrichment membrane of the present disclosure, the tetraalkoxysilane is preferably a tetramethoxysilane or a tetraethoxysilane (referred to as “A”), and the hydrocarbon group-containing dialkoxysilane is preferably dimethyldimethoxysilane or diethyldiethoxysilane (referred to as “B”).

According to the example oxygen enrichment membrane having the above constitution, materials appropriate for the tetraalkoxysilane and the hydrocarbon group-containing dialkoxysilane are selected. Therefore, an oxygen enrichment membrane that is easy to produce and has oxygen separation performance and rigidity that are well balanced, and is easy to handle, can be achieved.

In the above example oxygen enrichment membrane of the present disclosure, the mixing ratio (A/B) of the A and the B as expressed in a molar ratio is preferably 1/9-9/1.

According to the example oxygen enrichment membrane having the above constitution, the mixing ratio (A/B) of the tetramethoxysilane or tetraethoxysilane (A) and the dimethyldimethoxysilane or diethyldiethoxysilane (B) as expressed in a molar ratio is appropriate. Therefore, an optimum oxygen enrichment membrane for industrial use that has both good oxygen separation performance and good rigidity can be achieved.

In the above example oxygen enrichment membrane of the present disclosure, the hydrocarbon group-containing polysiloxane network structure material preferably additionally includes a metal salt having affinity for oxygen.

According to the example oxygen enrichment membrane having the above constitution, a metal salt having affinity for oxygen has an action of accelerating the oxygen separation performance of the hydrocarbon group-containing polysiloxane network structure material. Therefore, the affinity for oxygen of the metal salt and the oxygen selectivity of the hydrocarbon group have a synergistic effect, resulting in still higher oxygen separation performance of the oxygen enrichment membrane.

In the above example oxygen enrichment membrane of the present disclosure, the metal salt is preferably an acetate, nitrate, carbonate, borate, or phosphate of at least one metal selected from the group consisting of Li, Na, K, Mg, Ca, Ni, Fe, and Al.

According to the example oxygen enrichment membrane having the above constitution, the above significant metal salt is selected as the metal salt having affinity for oxygen, resulting in still higher oxygen separation performance.

In the above example oxygen enrichment membrane of the present disclosure, the hydrocarbon group-containing polysiloxane network structure material is preferably provided on a surface of an inorganic porous support member with a middle layer being interposed between the hydrocarbon group-containing polysiloxane network structure material and the surface of the inorganic porous support member.

According to the example oxygen enrichment membrane having the above constitution, the hydrocarbon group-containing polysiloxane network structure material is provided on a surface of an inorganic porous support member with a middle layer being interposed between the hydrocarbon group-containing polysiloxane network structure material and the surface of the inorganic porous support member. Therefore, during production of the oxygen enrichment membrane, excessive permeation of a material solution for the hydrocarbon group-containing polysiloxane network structure material into the inorganic porous support member can be prevented or reduced, resulting in an improvement in the ease of membrane formation of the hydrocarbon group-containing polysiloxane network structure material.

In the above example oxygen enrichment membrane of the present disclosure, the middle layer is preferably a polysiloxane network structure material or hydrocarbon group-containing polysiloxane network structure material which is a sol-gel reaction product of an alkoxysilane or alkoxysilanes including a tetraalkoxysilane and/or a hydrocarbon group-containing trialkoxysilane.

According to the example oxygen enrichment membrane having the above constitution, the tetraalkoxysilane and hydrocarbon group-containing trialkoxysilane that are materials for the middle layer, and the tetraalkoxysilane and hydrocarbon group-containing dialkoxysilane that are materials for the hydrocarbon group-containing polysiloxane network structure material, have similar structures and belong to the same category. Therefore, tight adhesion between the middle layer and the hydrocarbon group-containing polysiloxane network structure material at their interface is improved, and therefore, peeling and cracking of the hydrocarbon group-containing polysiloxane network structure material can be prevented or reduced.

An example method for producing an oxygen enrichment membrane according to the present disclosure, includes:

(a) a preparation step of formulating a first mixture solution which is a mixture of an alkoxysilane or alkoxysilanes including a tetraalkoxysilane and/or a hydrocarbon group-containing trialkoxysilane, an acid catalyst, water, and an organic solvent, and a second mixture solution which is a mixture of a tetraalkoxysilane, a hydrocarbon group-containing dialkoxysilane, an acid catalyst, water, and an organic solvent;

(b) a first application step of applying the first mixture solution to a surface of an inorganic porous support member;

(c) a middle layer formation step of thermally treating the inorganic porous support member after the end of the first application step, to form a middle layer including a polysiloxane network structure material on the surface of the inorganic porous support member;

(d) a second application step of applying the second mixture solution to the middle layer; and

(e) an oxygen enrichment layer formation step of thermally treating the inorganic porous support member after the end of the second application step, to form an oxygen enrichment layer including a hydrocarbon group-containing polysiloxane network structure material on the middle layer.

The example oxygen enrichment membrane production method having the above constitution have good effects similar to those of the above oxygen enrichment membrane. Specifically, an industrially applicable oxygen enrichment membrane having both good oxygen separation performance derived from the hydrocarbon group-containing dialkoxysilane and rigidity derived from the tetraalkoxysilane can be achieved. Also, the hydrocarbon group-containing polysiloxane network structure material is provided on the surface of the inorganic porous support member with the middle layer being interposed between the hydrocarbon group-containing polysiloxane network structure material and the surface of the inorganic porous support member. Therefore, during production of the oxygen enrichment membrane, excessive permeation of the second mixture solution into the inorganic porous support member can be prevented or reduced, resulting in an improvement in the ease of membrane formation of the oxygen enrichment layer formed on the middle layer.

In the above example oxygen enrichment membrane production method of the present disclosure, the preparation step preferably includes additionally mixing a metal salt having affinity for oxygen into the second mixture solution.

The example oxygen enrichment membrane production method having the above constitution provides good effects similar to those of the above oxygen enrichment membrane. Specifically, a metal salt having affinity for oxygen has an action of accelerating the oxygen separation performance of the hydrocarbon group-containing polysiloxane network structure material. Therefore, the affinity for oxygen of the metal salt and the oxygen selectivity of the hydrocarbon group have a synergistic effect, resulting in still higher oxygen separation performance of the oxygen enrichment membrane.

### BRIEF DESCRIPTION OF DRAWINGS

FIG. 1 is a schematic diagram of a configuration of an oxygen concentration measuring apparatus used in an oxygen enrichment performance verification test.

### DETAILED DESCRIPTION

Embodiments of an oxygen enrichment membrane according to the present disclosure and a method for producing the oxygen enrichment membrane will now be described. Note that the present disclosure is not intended to be limited to constitutions described below.

<Oxygen Enrichment Membrane>

An oxygen enrichment membrane according to the present disclosure includes an inorganic porous support member as a base and an oxygen enrichment layer formed thereon. Examples of a material for the inorganic porous support member include silica ceramics, silica glasses, alumina ceramics, stainless steel, titanium, silver, and the like. Of them, alumina ceramics have good heat resistance and are easy to process, and are available at relatively low cost, and therefore, are suitable as a material for the support member. The inorganic porous support member is preferably a columnar object that has a porous internal structure having communication pores, and a cylindrical air permeable outer surface surrounding the porous internal structure. Examples of the porous internal structure include: a monolith structure which is a single element having a large number of flow passages like holes of a lotus rhizome; a communication structure including continuous pores intertwined in a complex manner, a solid porous structure obtained by molding a porous material into a columnar shape; a hollow porous structure obtained by molding a porous material into a barrel shape; a honeycomb structure obtained by arranging honeycomb structure members in a pipe shape; and the like. Of them, the monolith structure is preferable to application to a gas separation membrane because such a structure can provide a sufficiently large gas contact area. The air permeable outer surface of the support member is in communication with the porous internal structure, and includes a very large number of pores. This structure allows, for example, gas that enters the columnar support member from an end (a top or bottom surface) thereof to pass through the porous internal structure and flow out from the entire air permeable outer surface. The size of the pore can be selected from the range from the nanometer to the micrometer scale, depending on the application, and is preferably 4-200 nm. The inorganic porous support member may have other structures, such as a cylindrical structure including a gas flow passage(s), a circular pipe structure, a spiral structure, and the like. Alternatively, the inorganic porous support member may be constructed by preparing a solid board or bulk formed of an inorganic porous material and then removing a part thereof to dig a gas flow passage(s).

The oxygen enrichment layer is preferably formed with a middle layer being interposed between it and the inorganic porous support member. For example, if a mixture (sol) containing an oxygen enrichment layer-forming material described below is directly applied to a surface of the inorganic porous support member having pores with a relatively large size, the mixture may excessively permeate the pores without remaining on the surface of the inorganic porous support member, leading to difficulty in forming the oxygen enrichment layer. To address this, if a middle layer is previously provided on the surface of the inorganic porous support member (including a surface of the porous internal structure), the middle layer narrows the entrance of the pore, which makes it easier to apply the mixture. In addition, the middle layer levels out the surface of the inorganic porous support member, which can prevent or reduce peeling and cracking of the oxygen enrichment layer. The middle layer and the oxygen enrichment layer that are provided in the oxygen enrichment membrane of the present disclosure will now be described in greater detail.

(Middle Layer)

(1) Polysiloxane Network Structure Material

The middle layer is formed to contain a silane compound. The middle layer of this embodiment contains a polysiloxane network structure material. The polysiloxane network structure material is a reaction product obtained by a sol-gel reaction of an alkoxysilane(s) including a tetraalkoxysilane and/or a hydrocarbon group-containing trialkoxysilane. Thus, the tetraalkoxysilane and the hydrocarbon group-containing trialkoxysilane are a precursor of the polysiloxane network structure material.

The tetraalkoxysilane is a tetrafunctional alkoxysilane represented by the following formula (1).

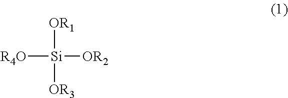

R₁-R₄: the same or different alkyl group having 1 or 2 carbon atoms

The tetraalkoxysilane is preferably tetramethoxysilane (TMOS), in which R₁-R₄ are all a methyl group in Formula (1), or tetraethoxysilane (TEOS), in which R₁-R₄ are all an ethyl group.

If the alkoxysilane(s) that is a material for the middle layer includes only a tetraalkoxysilane, then when the tetraalkoxysilane of Formula (1) is subjected to a sol-gel reaction, a polysiloxane network structure material is obtained in which siloxane bonds (Si—O bonds) are linked together in a three-dimensional fashion.

Meanwhile, the hydrocarbon group-containing trialkoxysilane containing a hydrocarbon group is a trifunctional alkoxysilane represented by the following formula (2).

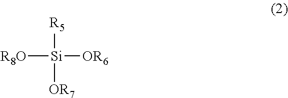

R₅: an alkyl group having 1-6 carbon atoms or a phenyl group
R₆-R₈: the same or different alkyl group having 1 or 2 carbon atoms

The hydrocarbon group-containing trialkoxysilane is preferably a trimethoxysilane in which R₆-R₈ are all a methyl group in Formula (2) and in which an alkyl group having 1-6 carbon atoms or a phenyl group is bonded with the Si atom in Formula (2), or a triethoxysilane in which R₆-R₈ are all an ethyl group in Formula (2) and in which an alkyl group having 1-6 carbon atoms or a phenyl group is bonded with the Si atom in Formula (2). Examples of the hydrocarbon group-containing trialkoxysilane include methyltrimethoxysilane, methyltriethoxysilane, ethyltrimethoxysilane, ethyltriethoxysilane, propyltrimethoxysilane, propyltriethoxysilane, butyltrimethoxysilane, butyltriethoxysilane, pentyltrimethoxysilane, pentyltriethoxysilane, hexyltrimethoxysilane, hexyltriethoxysilane, phenyltrimethoxysilane, and phenyltriethoxysilane.

If the alkoxysilane(s) that is a material for the middle layer includes a tetraalkoxysilane and a hydrocarbon group-containing trialkoxysilane, then when the tetraalkoxysilane of Formula (1) and the hydrocarbon group-containing trialkoxysilane of Formula (2) are subjected to a sol-gel reaction, a polysiloxane network structure material is obtained that has a molecular structure represented by Formula (3) below, for example. In the polysiloxane network structure material of Formula (3), a hydrocarbon group R₅ is present in the polysiloxane network structure, which forms a certain kind of organic-inorganic complex. Also, if the alkoxysilane(s) that is a material for the middle layer includes only a hydrocarbon group-containing trialkoxysilane, then when the hydrocarbon group-containing trialkoxysilane of Formula (2) is subjected to a sol-gel reaction, the density of the hydrocarbon group R₅ increases in the polysiloxane network structure material of Formula (3).

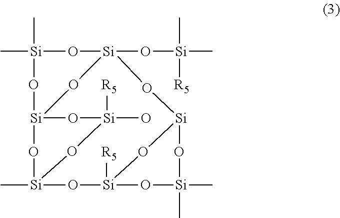

R₅: an alkyl group having 1-6 carbon atoms or a phenyl group

The polysiloxane network structure material forms an inorganic porous object having an indefinite shape that has a dense polysiloxane network structure. A metal salt having affinity for oxygen may be added to the polysiloxane network structure material, i.e., the polysiloxane network structure material may be doped with such a metal salt. Examples of such a metal salt include an acetate, nitrate, carbonate, borate, or phosphate of at least one metal selected from the group consisting of Li, Na, K, Mg, Ca, Ni, Fe, and Al. Of them, magnesium nitrate is used as a preferable metal salt. The metal salt is easily added to the polysiloxane network structure material by previously adding the metal salt to a material for the polysiloxane network structure material. Alternatively, for example, the produced polysiloxane network structure material may be immersed in an aqueous solution containing the metal salt so that the polysiloxane network structure material is impregnated with the metal salt alone or in combination with other materials (this technique is called an impregnation technique).

(2) Silica Particle-Bonded Material

In the above embodiment, the middle layer is assumed to contain a polysiloxane network structure material that is obtained by a sol-gel reaction of a tetraalkoxysilane. Alternatively, a silica particle-bonded material obtained by a sintering reaction of colloidal silica may be used as the middle layer.

Colloidal silica is a dispersion of silica particles (silica sol) containing silicon oxide (SiO₂) as a main ingredient in a solvent. The particle size of silica particles is typically adjusted to about 10-300 nm. Examples of the solvent in which silica particles are dispersed include water, methanol, ethanol, propanol, ethylene glycol, dimethylacetamide, ethyl acetate, toluene, methyl ethyl ketone, methyl isobutyl ketone, cyclohexanone, and the like. As such colloidal silica, for example, colloidal silica “SNOWTEX (registered trademark)” available from Nissan Chemical Industries, Ltd. may be used.

When colloidal silica is heated, the dispersion medium of the silica particles evaporates, so that the surfaces of the silica particles are made contact with each other. If the colloidal silica is further heated, the surfaces of the silica particles fuse together (sintering reaction). As a result, a silica particle-bonded material is obtained in which silica particles are linked in a three-dimensional manner. The silica particle-bonded material has a continuous structure formed by fusion of the surfaces of the silica particles, and a porous structure formed by spaces between the silica particles. Thus, the silica particle-bonded material forms an inorganic porous object having an indefinite shape that contains silicon oxide as a main ingredient.

(Oxygen Enrichment Layer)

The oxygen enrichment layer includes a hydrocarbon group-containing polysiloxane network structure material. The hydrocarbon group-containing polysiloxane network structure material is a reaction product obtained by a sol-gel reaction of a tetraalkoxysilane and a hydrocarbon group-containing dialkoxysilane. Thus, the tetraalkoxysilane and the hydrocarbon group-containing dialkoxysilane are a precursor of the hydrocarbon group-containing polysiloxane network structure material. Here, the tetraalkoxysilane imparts rigidity to the oxygen enrichment layer, and the hydrocarbon group-containing dialkoxysilane improves the affinity for oxygen (i.e., oxygen separation performance) of the oxygen enrichment layer.

As the tetraalkoxysilane, one that is similar to the tetrafunctional alkoxysilane represented by Formula (1) above that is used for the formation of the middle layer, can be used. As in the middle layer, the tetraalkoxysilane is preferably a tetramethoxysilane (TMOS) in which R₁-R₄ are all a methyl group in Formula (1) or a tetraethoxysilane (TEOS) in which R₁-R₄ are all an ethyl group in Formula (1).

The hydrocarbon group-containing dialkoxysilane containing a hydrocarbon group is a bifunctional alkoxysilane represented by the following formula (4).

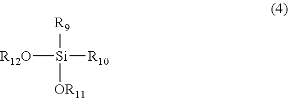

R₉, R₁₀: the same or different alkyl group having 1-6 carbon atoms or a phenyl group
R₁₁, R₁₂: the same or different alkyl group having 1 or 2 carbon atoms

The hydrocarbon group-containing dialkoxysilane is preferably a dimethoxysilane in which R₁₁ and R₁₂ are all a methyl group in Formula (4) and in which an alkyl group having 1-6 carbon atoms or a phenyl group is bonded with the Si atom in Formula (4), or a diethoxysilane in which R₁₁ and R₁₂ are all an ethyl group in Formula (4) and in which an alkyl group having 1-6 carbon atoms or a phenyl group is bonded with the Si atom in Formula (4). Examples of the hydrocarbon group-containing dialkoxysilane include dimethyldimethoxysilane, dimethyldiethoxysilane, diethyldimethoxysilane, diethyldiethoxysilane, dipropyldimethoxysilane, dipropyldiethoxysilane, dibutyldimethoxysilane, dibutyldiethoxysilane, dipentyldimethoxysilane, dipentyldiethoxysilane, dihexyldimethoxysilane, dihexyldiethoxysilane, diphenyldimethoxysilane, and diphenyldiethoxysilane. Of them, dimethyldimethoxysilane and diethyldiethoxysilane are more preferably used.

A sol-gel reaction of the tetraalkoxysilane of Formula (1) and the hydrocarbon group-containing dialkoxysilane of Formula (4) will result in, for example, a hydrocarbon group-containing polysiloxane network structure material represented by the following formula (5).

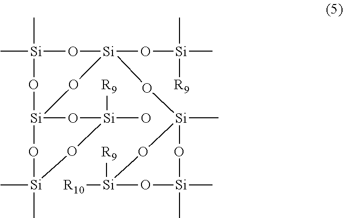

R₉, R₁₀: the same or different alkyl group having 1-6 carbon atoms or a phenyl group

In the hydrocarbon group-containing polysiloxane network structure material of Formula (5), the hydrocarbon groups R₉ and R₁₀ are present in the polysiloxane network structure, which forms a certain kind of organic-inorganic complex.

When the hydrocarbon group-containing polysiloxane network structure material of Formula (5) is synthesized by a reaction of the tetraalkoxysilane of Formula (1) and the hydrocarbon group-containing dialkoxysilane of Formula (4), then if the mixing ratio of the tetraalkoxysilane (referred to as “A”) and the hydrocarbon group-containing dialkoxysilane (referred to as “B”) is optimized, an oxygen enrichment layer having oxygen separation performance and rigidity that are well balanced can be formed. The mixing ratio A/B as expressed in a molar ratio is appropriately 1/9-9/1, preferably 3/7-9/1, and more preferably 4/6-9/1. With such a mixing ratio, a hydrocarbon group-containing polysiloxane network structure material having both a stable structure and high affinity for oxygen can be efficiently obtained, and therefore, the oxygen separation performance and rigidity of an oxygen enrichment layer formed therefrom are well balanced.

In order to further increase the oxygen separation performance of the oxygen enrichment layer, a metal salt having affinity for oxygen is preferably added to the hydrocarbon group-containing polysiloxane network structure material of Formula (5), i.e., the hydrocarbon group-containing polysiloxane network structure material of Formula (5) is preferably doped with such a metal salt, as in the middle layer. A metal salt having affinity for oxygen (e.g., magnesium nitrate) has an action of accelerating the oxygen separation performance of the hydrocarbon group-containing polysiloxane network structure material. Therefore, for example, if the hydrocarbon groups R₉ and R₁₀ contained in the polysiloxane network structure are a methyl group, the affinity for oxygen of the metal salt and the oxygen selectivity of the methyl group have a synergistic effect, which allows for highly efficient separation of oxygen. The metal salt can be added to the hydrocarbon group-containing polysiloxane network structure material in a manner similar to that in which a metal salt is added to the middle layer.

<Method for Producing Oxygen Enrichment Membrane>

The oxygen enrichment membrane of the present disclosure is produced by performing steps (a) to (e) below. In this embodiment, the oxygen enrichment membrane including a polysiloxane network structure material as the middle layer and a hydrocarbon group-containing polysiloxane network structure material as the oxygen enrichment layer will be described. Each of the steps for performing a method for producing the oxygen enrichment membrane of the present disclosure will now be described in detail.

(a) Preparation Step

A preparation step includes formulating a first mixture solution containing an alkoxysilane(s) including a tetraalkoxysilane and/or a hydrocarbon group-containing trialkoxysilane, an acid catalyst, water, and an organic solvent. The first mixture solution is used in the next step “first application step.” The amounts of the alkoxysilane(s) (a tetraalkoxysilane and/or a hydrocarbon group-containing trialkoxysilane), acid catalyst, water, and organic solvent in the mixture are preferably adjusted so that the amount of the acid catalyst is 0.001-0.1 mol, the amount of the water is 0.5-60 mol, and the amount of the organic solvent is 5-60 mol with respect to one mole of the alkoxysilane(s). If the amount of the acid catalyst in the mixture is less than 0.001 mol, the rate of hydrolysis is low, and therefore, it takes a long time to produce the oxygen enrichment membrane. If the amount of the acid catalyst in the mixture is more than 0.1 mol, the rate of hydrolysis is excessively high, and therefore, it is difficult to obtain a uniform oxygen enrichment membrane. If the amount of the water in the mixture is less than 0.5 mol, the rate of hydrolysis is low, and therefore, a sol-gel reaction described below does not proceed sufficiently. If the amount of the water in the mixture is more than 60 mol, the rate of hydrolysis is excessively high, and therefore, the pore size increases, which makes it difficult to obtain a dense oxygen enrichment membrane. Also, the ease of membrane formation deteriorates. If the amount of the organic solvent in the mixture is less than 5 mol, the concentration of the first mixture solution is high, and therefore, it is difficult to obtain a dense and uniform oxygen enrichment membrane. If the amount of the organic solvent in the mixture is more than 60 mol, the concentration of the first mixture solution is low, and therefore, the number of times the mixture solution is applied (number of steps) increases, resulting in a decrease in production efficiency. Examples of the acid catalyst used include nitric acid, hydrochloric acid, sulfuric acid, and the like. Of them, nitric acid or hydrochloric acid is preferable. Examples of the organic solvent used include methanol, ethanol, propanol, butanol, benzene, toluene, and the like. Of them, methanol or ethanol is preferable. When the first mixture solution is formulated, a metal salt having affinity for oxygen may be added to the solution. The amount of the metal salt in the mixture is adjusted to 0.01-0.3 mol under the above mixture conditions. The metal salt having affinity for oxygen may be preferably magnesium nitrate, which is described in the above section “Oxygen Enrichment Membrane.”

In the first mixture solution, a sol-gel reaction begins to occur in which the alkoxysilane(s) repeatedly undergoes hydrolysis and polycondensation. The alkoxysilane(s) used may be any of those described in the above section “Oxygen Enrichment Membrane.” For example, if tetraethoxysilane (TEOS) is used as an example of the tetraalkoxysilane, the sol-gel reaction may proceed according to Scheme 1 below. Note that Scheme 1 is a model representing the process of the sol-gel reaction, and may not necessarily exactly correspond to the actual molecular structure.

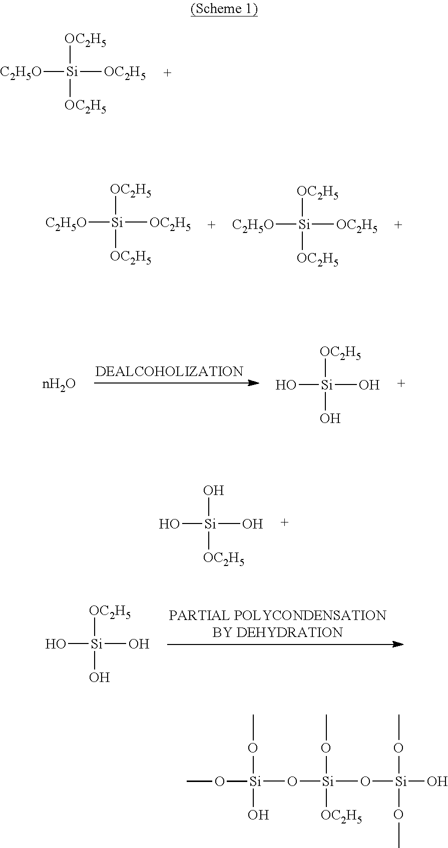

According to Scheme 1, a portion of the ethoxy groups of tetraethoxysilane is hydrolyzed for dealcoholization to produce a silanol group(s). Also, a portion of the ethoxy groups of tetraethoxysilane may not be hydrolyzed and may remain unchanged. Next, a portion of the silanol groups is associated with a neighboring silanol group(s) to undergo polycondensation due to dehydration. As a result, a siloxane backbone with remaining silanol groups or ethoxy groups is formed. The above hydrolysis reaction and dehydration/polycondensation reaction proceed substantially uniformly in the mixture solution system, so that the silanol groups or the ethoxy groups are substantially uniformly distributed in the siloxane backbone. When a metal salt is added, the metal salt incorporated in the polysiloxane during the sol-gel reaction may be substantially uniformly distributed in the polysiloxane. In this stage, the molecular weight of the siloxane is not significantly large, i.e., the siloxane is an oligomer rather than a polymer. Therefore, the silanol group-containing or ethoxy group-containing siloxane oligomer is dissolved in the first mixture solution containing an organic solvent. After the reaction has further proceeded, the solution becomes a suspension in which minute polysiloxane network structure materials are dispersed.

When the alkoxysilane of the first mixture solution further includes a hydrocarbon group-containing trialkoxysilane, a reaction begins to occur between the silanol group-containing or ethoxy group-containing siloxane oligomer and the hydrocarbon group-containing trialkoxysilane. The hydrocarbon group-containing trialkoxysilane may be any of those described in the above section “Oxygen Enrichment Membrane.” For example, when methyltriethoxysilane is used as an example of the hydrocarbon group-containing trialkoxysilane, the reaction may proceed according to Scheme below. Note that Scheme 2 is a model representing the process of the reaction, and may not necessarily exactly correspond to the actual molecular structure.

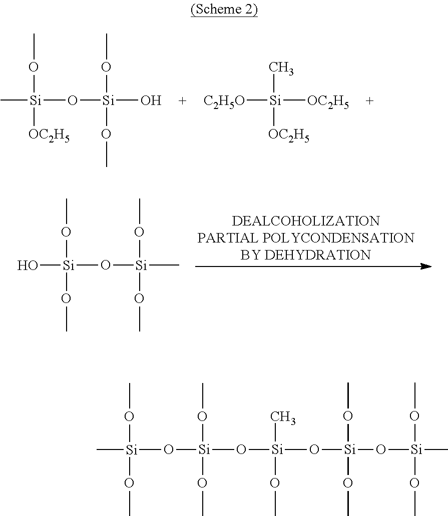

According to Scheme 2, a silanol group or ethoxy group of a siloxane oligomer and an ethoxy group of methyltriethoxysilane react with each other to undergo dealcoholization, resulting in a polysiloxane. Here, silanol groups or ethoxy groups of a siloxane oligomer are substantially uniformly distributed in the siloxane backbone as described above. Therefore, the reaction (dealcoholization) of silanol groups or ethoxy groups of a siloxane oligomer and ethoxy groups of methyltriethoxysilane may substantially uniformly proceed. As a result, a siloxane bond derived from methyltriethoxysilane is substantially uniformly produced in the produced polysiloxane, and therefore, a methyl group derived from methyltriethoxysilane is also substantially uniformly present in the polysiloxane. If the reaction further proceeds, the solution becomes a suspension in which minute hydrocarbon group-containing polysiloxane network structure materials are dispersed.

The preparation step further includes formulating a second mixture solution which is a mixture of a tetraalkoxysilane, a hydrocarbon group-containing dialkoxysilane, an acid catalyst, water, and an organic solvent. The second mixture solution is used in a “second application step” described below. The amounts of the tetraalkoxysilane, hydrocarbon group-containing dialkoxysilane, acid catalyst, water, and organic solvent in the mixture are preferably adjusted so that the amount of the acid catalyst is 0.005-0.1 mol, the amount of the water is 0.017-3 mol, and the amount of the organic solvent is 5-60 mol with respect to a total of one mole of the tetraalkoxysilane and hydrocarbon group-containing dialkoxysilane. If the amount of the acid catalyst in the mixture is less than 0.005 mol, the rate of hydrolysis is low, and therefore, it takes a long time to produce an oxygen enrichment membrane. If the amount of the acid catalyst in the mixture is more than 0.1 mol, the rate of hydrolysis is excessively high, and therefore, it is difficult to obtain a uniform oxygen enrichment membrane. If the amount of the water in the mixture is less than 0.017 mol, the rate of hydrolysis is low, and therefore, a sol-gel reaction described below does not proceed sufficiently. If the amount of the water in the mixture is more than 3 mol, the rate of hydrolysis is excessively high, and therefore, the pore size increases, which makes it difficult to obtain a dense oxygen enrichment membrane. If the amount of the organic solvent in the mixture is less than 5 mol, the second mixture solution has a high concentration, and therefore, it is difficult to obtain a dense and uniform oxygen enrichment membrane. If the amount of the organic solvent in the mixture is more than 60 mol, the second mixture solution has a low concentration, and therefore, the number of times the mixture solution is applied (the number of steps) increases, resulting in a decrease in production efficiency. The acid catalyst and the organic solvent may be similar to those of the first mixture solution. When the second mixture solution is formulated, a metal salt having affinity for oxygen may be added. The amount of the metal salt in the mixture is adjusted to 0.01-0.3 mol under the above mixture conditions. The metal salt having affinity for oxygen may be preferably magnesium nitrate, which is described in the above section “Oxygen Enrichment Membrane.”

In the second mixture solution, initially, a sol-gel reaction proceeds in which the tetraalkoxysilane repeatedly undergoes hydrolysis and polycondensation as in Scheme 1, so that a silanol group-containing or ethoxy group-containing siloxane oligomer is dissolved in the second mixture solution containing the organic solvent. Next, a reaction of the siloxane oligomer and the hydrocarbon group-containing dialkoxysilane begins to occur. The hydrocarbon group-containing dialkoxysilane used may be any of those described in the above section “Oxygen Enrichment Membrane.” For example, when dimethyldimethoxysilane is used as an example of the hydrocarbon group-containing dialkoxysilane, the reaction may proceed according to Scheme 3 below. Note that Scheme 3 is a model representing the process of the reaction, and may not necessarily exactly correspond to the actual molecular structure.

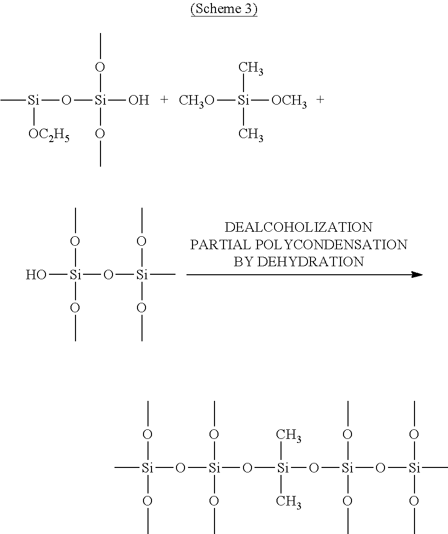

According to Scheme 3, a silanol group or ethoxy group of a siloxane oligomer and a methoxy group of dimethyldimethoxysilane react with each other to undergo dealcoholization, resulting in a polysiloxane. Here, silanol groups or ethoxy groups of a siloxane oligomer are substantially uniformly distributed in the siloxane backbone as described above. Therefore, the reaction (dealcoholization) of silanol groups or ethoxy groups of a siloxane oligomer and methoxy groups of dimethyldimethoxysilane may substantially uniformly proceed. As a result, a siloxane bond derived from dimethyldimethoxysilane is substantially uniformly produced in the produced polysiloxane, and therefore, a methyl group derived from dimethyldimethoxysilane is also substantially uniformly present in the polysiloxane. When a metal salt is added, the metal salt incorporated in the polysiloxane during the sol-gel reaction may be substantially uniformly distributed in the polysiloxane. The second mixture solution becomes a suspension in which minute hydrocarbon group-containing polysiloxane network structure materials are dispersed.

For the formulation of the second mixture solution, the acid catalyst may be preferably added in divided portions, the hydrocarbon group-containing dialkoxysilane, which is easily hydrolyzed, may be preferably mixed at the end, or the like. For example, the composition of the mixture solution is formulated so that the pH of the mixture solution is invariably within the range of 0.8-2.5. In this case, the pH of the second mixture solution does not vary significantly, and therefore, the hydrolysis of the hydrocarbon group-containing dialkoxysilane does not proceed rapidly, so that the sol-gel reaction is allowed to proceed in a stable manner.

(b) First Application Step

A first application step includes applying the first mixture solution (a suspension of the minute polysiloxane network structure material or hydrocarbon group-containing polysiloxane network structure material) obtained in the preparation step to an inorganic porous support member. Examples of a technique of applying the first mixture solution to the inorganic porous support member include dipping, spraying, spinning, and the like. Of them, dipping is preferable because the mixture solution can be uniformly and easily applied to the surface of the porous internal structure of the inorganic porous support member (i.e., pores inside the inorganic porous support member). A specific procedure for dipping will be described.

Initially, the inorganic porous support member is immersed in the first mixture solution. The immersion time is preferably 5 sec to 10 min in order to allow the first mixture solution to sufficiently adhere to the inorganic porous support member. If the immersion time is shorter than 5 sec, a sufficient thickness is not obtained. If the immersion time exceeds 10 min, an excessively large thickness is obtained. Next, the inorganic porous support member is pulled out of the first mixture solution. A speed at which the inorganic porous support member is pulled out (referred to as a “pulling speed”) is set to 0.1-50 mm/sec, preferably 0.5-5 mm/sec. If the pulling speed is slower than 0.1 mm/sec, it takes a long time to pull out the inorganic porous support member, leading to a decrease in production efficiency. If the pulling speed exceeds 50 mm/sec, an excessively large thickness is obtained, and sagging of the solution during pulling out is likely to occur, leading to a non-uniform membrane. Note that, in the first application step, instead of immersing the support member in the material solution, the support member may be positioned with both ends (top and bottom surfaces) thereof facing in the vertical direction, and the material solution may be poured into the support member from above (through the top surface), passed through the porous internal structure, and drained downward from the support member (through the bottom surface). In this case, by adjusting the flow rate of the material solution passed through the porous internal structure, the material solution can be applied in an appropriate amount. Next, the inorganic porous support member pulled out is dried. The drying is performed at a drying temperature of 15-40° C., preferably 20-35° C., for a drying time of 0.5-24 h, preferably 1-3 h. If the drying temperature is less than 15° C. or the drying time is less than 0.5 h, the drying is insufficient, so that the membrane surface may remain sticky. Meanwhile, if the drying temperature exceeds 40° C. or the drying time exceeds 24 h, the membrane is dried to the maximum extent, and the excessively dried membrane is likely to have an uneven surface. After the end of the drying, the inorganic porous support member with the minute polysiloxane network structure material or hydrocarbon group-containing polysiloxane network structure material adhering to the surface thereof (including the inner surface of a portion of the pores) is obtained. Note that, by performing the above series of steps, i.e., the immersion, pulling-out, and drying steps, on the inorganic porous support member a plurality of times, the amount of the minute polysiloxane network structure or hydrocarbon group-containing polysiloxane network structure material adhering to the inorganic porous support member can be increased. Also, by repeatedly performing the series of steps, the first mixture solution can be uniformly applied to the inorganic porous support member, and therefore, the oxygen enrichment membrane finally obtained can be stabilized.

(c) Middle Layer Formation Step

A middle layer formation step includes thermally treating the inorganic porous support member after the end of the first application step, to fix or fuse the minute polysiloxane network structure material or hydrocarbon group-containing polysiloxane network structure material to the surface of the inorganic porous support member, thereby forming a middle layer including the polysiloxane network structure material or the hydrocarbon group-containing polysiloxane network structure material as a main component. For the thermal treatment, for example, a heating means, such as a baking device or the like, is used. A specific procedure for the thermal treatment will be described.

Initially, the temperature of the inorganic porous support member is increased until it reaches a thermal treatment temperature described below. The temperature increasing rate is preferably 15-275° C./h. If the temperature increasing rate is lower than 15° C./h, the time it takes to reach the predetermined thermal treatment temperature increases, leading to a decrease in production efficiency. If the temperature increasing rate is higher than 275° C./h, the rapid change in temperature inhibits formation of a uniform membrane, and is also likely to cause cracks in the membrane. After the increase of the temperature, a thermal treatment (baking) is performed for a predetermined period of time. The thermal treatment temperature is preferably 40-300° C., more preferably 50-200° C. If the thermal treatment temperature is lower than 40° C., the thermal treatment is not sufficient, so that a dense membrane is not obtained. If the thermal treatment temperature is higher than 300° C., the high-temperature heating is likely to deteriorate the membrane. The thermal treatment time is preferably 0.5-6 h. If the thermal treatment time is shorter than 0.5 h, the thermal treatment is not sufficient, so that a dense membrane is not obtained. If the thermal treatment time is longer than 6 h, the long-time heating is likely to deteriorate the membrane. After the end of the thermal treatment, the inorganic porous support member is cooled to room temperature. The cooling time is preferably 5-10 h. If the cooling time is shorter than 5 h, the rapid change in temperature is likely to cause the membrane to crack or come off. If the cooling time is longer than 10 h, the membrane is likely to deteriorate. The inorganic porous support member after the cooling has a middle layer formed on the surface (including inner surfaces of a portion of pores) of the porous internal structure thereof. At this time, the weight of the middle layer is adjusted to 0.1-4.0 mg/cm², preferably 0.5-3.0 mg/cm², and more preferably 2.0-2.5 mg/cm². Note that, after the “middle layer formation step,” the process may return to the above “first application step.” If the set of the first application step and the middle layer formation step is performed a plurality of times, a denser middle layer having more uniform membrane quality can be formed on the surface of the inorganic porous support member.

(d) Second Application Step

A second application step includes applying the second mixture solution (a suspension of the minute hydrocarbon group-containing polysiloxane network structure material) to the inorganic porous support member having the middle layer formed by the middle layer formation step. In the second application step, the second mixture solution is applied to the inorganic porous support member with the middle layer being interposed therebetween. Therefore, the amount of the second mixture solution that permeates the inorganic porous support member (a distance in the depth direction from the surface of the porous internal structure, by which the tetraalkoxysilane or the hydrocarbon group-containing dialkoxysilane permeates the inorganic porous support member) can be limited to 50 μm or less. Therefore, the pores of the inorganic porous support member are not excessively blocked. As a result, when oxygen-containing gas, such as air or the like, is passed through the oxygen enrichment membrane finally obtained by an oxygen enrichment layer formation step described below, the rate of passing gas (the rate of processing gas) can be maintained. In addition, the amounts of the middle layer-forming material (sol) and the oxygen enrichment layer-forming material (sol) applied to the inorganic porous support member can be reduced, which can contribute to a reduction in the manufacturing cost of the oxygen enrichment membrane. The second mixture solution is applied using a technique and conditions similar to those for the first application step. Also in the second application step, by performing the above series of steps, i.e., the step of immersion in the second mixture solution, the pulling-out step, and the drying step, on the inorganic porous support member a plurality of times, the amount of the minute hydrocarbon group-containing polysiloxane network structure material adhering to the inorganic porous support member can be increased. Also, by repeatedly performing the series of steps, the second mixture solution can be uniformly applied to the inorganic porous support member, and therefore, the separation performance of the oxygen enrichment membrane finally obtained can be further improved.

(e) Oxygen Enrichment Layer Formation Step

An oxygen enrichment layer formation step includes thermally treating the inorganic porous support member after the end of the second application step, to fix or fuse the minute hydrocarbon group-containing polysiloxane network structure material to the surface of the inorganic porous support member, thereby forming an oxygen enrichment layer including the hydrocarbon group-containing polysiloxane network structure material as a main component. The thermal treatment is performed using a technique and conditions similar to those for the middle layer formation step. By the oxygen enrichment layer formation step, the oxygen enrichment layer is formed on the middle layer. At this time, the weight of the oxygen enrichment layer is adjusted to 0.1-4.0 mg/cm², preferably 0.3-1.5 mg/cm², and more preferably 0.7-1.0 mg/cm². Note that, after the “oxygen enrichment layer formation step,” the process may return to the “second application step.” If the set of the second application step and the oxygen enrichment layer formation step is performed a plurality of times, a denser oxygen enrichment layer having more uniform membrane quality can be formed on the surface of the inorganic porous support member.

By performing the above steps (a)-(e), the oxygen enrichment membrane of the present disclosure is produced. The oxygen enrichment membrane has, on an inorganic porous support member as a base, an oxygen enrichment layer that has a site (e.g., a methyl group) that attracts oxygen. The oxygen enrichment layer is formed on the surface of the inorganic porous support member with the middle layer being interposed therebetween. Here, the tetraalkoxysilane and hydrocarbon group-containing trialkoxysilane that are materials for the middle layer, and the tetraalkoxysilane and hydrocarbon group-containing dialkoxysilane that are materials for the hydrocarbon group-containing polysiloxane network structure material, have similar structures and belong to the same category. Therefore, the polysiloxane network structure material and the hydrocarbon group-containing polysiloxane network structure material have high affinity for each other. Therefore, interface debonding, cracking, or the like does not occur between the middle layer and the oxygen enrichment layer, and the middle layer and the oxygen enrichment layer are firmly attached together, so that a stable oxygen enrichment membrane is formed. When oxygen-containing gas, such as air or the like, is passed through the oxygen enrichment membrane, oxygen in the oxygen-containing gas is selectively attracted to the surface of the hydrocarbon group-containing polysiloxane network structure material, and is then allowed to directly permeate the oxygen enrichment membrane. As a result, an enriched concentration of oxygen can be efficiently obtained.

### EXAMPLES

Examples relating to the oxygen enrichment membrane of the present disclosure will now be described.

<Production of Oxygen Enrichment Membrane>

An oxygen enrichment membrane was produced according to the “Method For Producing Oxygen Enrichment Membrane” described in the above embodiment. In all examples, the same tetraethoxysilane (Shin-Etsu Silicone LS-2430, manufactured by Shin-Etsu Chemical Co., Ltd.) was used as a tetraalkoxysilane, the same methyltriethoxysilane (Shin-Etsu Silicone LS-1890, manufactured by Shin-Etsu Chemical Co., Ltd.) was used as a hydrocarbon group-containing trialkoxysilane, the same dimethyldimethoxysilane (Shin-Etsu Silicone LS-520, manufactured by Shin-Etsu Chemical Co., Ltd.) was used as a hydrocarbon group-containing dialkoxysilane, the same nitric acid (super special grade reagent 69.5% manufactured by Wako Pure Chemical Industries, Ltd.) was used as an acid catalyst, and the same ethanol (super special grade reagent 99.5% manufactured by Wako Pure Chemical Industries, Ltd.) was used as an organic solvent. Materials and their amounts used in Examples 1-7 and Comparative Example 1 are shown in Table 1. Note that, in Table 1, the unit of the amount of each material in the mixture is “g” that is the unit of weight in a test actually conducted, and may be replaced by “part by weight.” In other words, the examples of the present disclosure can be scaled up by any factor.

TABLE 1

| | | | | | | | | | Comparative |
|---|---|---|---|---|---|---|---|---|---|
| | | Examples | | | | | | | Example |
| | | 1 | 2 | 3 | 4 | 5 | 6 | 7 | 1 |
| Middle | Tetraethoxysilane (g) | 17.44 | 17.44 | 17.44 | 17.44 | 17.44 | — | 17.44 | 17.44 |
| layer-forming | Methyltriethoxysilane (g) | 6.78 | 6.78 | — | 6.78 | 6.78 | — | 6.78 | 6.78 |
| alkoxide | Water (first portion) (g) | 3.01 | 3.01 | 75.37 | 3.01 | 3.01 | — | 3.01 | 3.01 |
| solution | Nitric acid | 0.02 | 0.02 | 0.02 | 0.02 | 0.02 | — | 0.02 | 0.02 |
| | Water (second portion) (g) | 72.36 | 72.36 | — | 72.36 | 72.36 | — | 72.36 | 72.36 |
| | Ethanol (g) | 77.17 | 77.17 | 77.17 | 77.17 | 77.17 | — | 77.17 | 77.17 |
| | Total | 176.75 | 176.75 | 170 | 176.75 | 176.75 | — | 176.75 | 176.75 |
| | Weight (mg/cm²) | 2.34 | 2.45 | 2.14 | 2.24 | 2.31 | — | 2.34 | 2.34 |
| Oxygen | Tetraethoxysilane (g) | 22.77 | 22.97 | 28.83 | 3.41 | 10.07 | 22.77 | 23.02 | — |
| enrichment | Dimethyldimethoxysilane (g) | 5.63 | 5.68 | 1.85 | 17.70 | 13.55 | 5.63 | 5.69 | 19.83 |
| layer-forming | Magnesium nitrate | 2.00 | 0.40 | 1.97 | 2.10 | 2.07 | 2.00 | — | 2.12 |
| alkoxide | hexahydrate (g) | | | | | | | | |
| solution | Water (g) | 5.62 | 5.67 | 5.54 | 5.89 | 5.80 | 5.62 | 5.68 | 5.94 |
| | Nitric acid (g) | 0.10 | 0.10 | 0.10 | 0.10 | 0.10 | 0.10 | 0.10 | 0.10 |
| | Ethanol (g) | 143.88 | 145.17 | 141.71 | 150.79 | 148.42 | 143.88 | 145.50 | 152.01 |
| | Total | 180.00 | 180.00 | 180.00 | 180.00 | 180.00 | 180.00 | 180.00 | 180.00 |
| | Weight (mg/cm²) | 0.77 | 0.83 | 0.94 | 1.12 | 1.01 | 3.75 | 1.01 | 0.89 |

### Example 1

Prior to production of the oxygen enrichment membrane, an alkoxide solution for forming the middle layer (first mixture solution) and an alkoxide solution for forming the oxygen enrichment layer (second mixture solution) were prepared. According to materials and their amounts shown in Table 1, a mixture solution of water (first portion), nitric acid, and ethanol was stirred for 30 min, then a tetraethoxysilane and water (second portion) were added to the mixture solution, followed by stirring for 2 h, and then methyltriethoxysilane was added to the mixture solution, followed by stirring for 2.5 h, to formulate the alkoxide solution for forming the middle layer (also referred to as the middle layer-forming alkoxide solution) (first mixture solution). Also, according to materials and their amounts shown in Table 1, a mixture solution of water, nitric acid, and ethanol was stirred for 30 min, then a tetraethoxysilane was added to the mixture solution, followed by stirring for 1 h, then dimethyldimethoxysilane was added to the mixture solution, followed by stirring for 2.5 h, and then magnesium nitrate hexahydrate was added to the mixture solution, followed by stirring for 2 h, to formulate the alkoxide solution for forming the oxygen enrichment layer (also referred to as the oxygen enrichment layer-forming alkoxide solution) (second mixture solution). In the oxygen enrichment layer-forming alkoxide solution of Example 1, the mixing ratio (A/B) of the tetraethoxysilane (A) and the dimethyldimethoxysilane (B) as expressed in a molar ratio is 7/3.

The middle layer-forming alkoxide solution and oxygen enrichment layer-forming alkoxide solution thus formulated were applied to an inorganic porous support member to produce an oxygen enrichment membrane including a middle layer and an oxygen enrichment layer. As the inorganic porous support member, a columnar object of an alumina ceramic having a monolith structure was used. Initially, the middle layer-forming alkoxide solution was applied to the surface of the porous internal structure of the columnar object by dipping. In the dipping step, the pulling speed was 5 mm/s, and after the pulling out, drying was performed at room temperature (25° C.) for 1 h. The application and drying of the middle layer-forming alkoxide solution were performed two times, followed by a thermal treatment in a baking device. The thermal treatment was performed under the following conditions: the temperature was increased from room temperature (25° C.) to 150° C. in 5 h (temperature increasing rate: 25° C./h); the temperature was maintained at 150° C. for 2 h; and the temperature was decreased to 25° C. in 5 h. The above process (coating) was performed three times to form a middle layer on a surface of the porous internal structure of the columnar object. The middle layer had a weight of 2.34 mg/cm². Next, the oxygen enrichment layer-forming alkoxide solution was applied to the surface of the porous internal structure of the columnar object having the middle layer by dipping. In the dipping step, the pulling speed was 5 mm/s, and after the pulling out, drying was performed at room temperature for 1 h. The application and drying of the oxygen enrichment layer-forming alkoxide solution were performed two times, followed by a thermal treatment using a baking device. The thermal treatment was performed under the following conditions: the temperature was increased from room temperature (25° C.) to 150° C. in 5 h (temperature increasing rate: 25° C./h); the temperature was maintained at 150° C. for 2 h; and the temperature was decreased to 25° C. in 5 h. The above process (coating) was performed two times to form an oxygen enrichment layer on the middle layer. The oxygen enrichment layer had a weight of 0.77 mg/cm². Thus, the oxygen enrichment membrane of Example 1 was finally produced. It was verified that the oxygen enrichment membrane of Example 1 has good ease of membrane formation and sufficient rigidity for practical use.

### Example 2

A middle layer-forming alkoxide solution (first mixture solution) and an oxygen enrichment layer-forming alkoxide solution (second mixture solution) were prepared, and were applied to a columnar object of an alumina ceramic having a monolith structure that is an inorganic porous support member, followed by a thermal treatment, to produce an oxygen enrichment membrane of Example 2 including a middle layer and an oxygen enrichment layer.

According to materials and their amounts shown in Table 1, a middle layer-forming alkoxide solution and an oxygen enrichment layer-forming alkoxide solution that were used in Example 2 were formulated using procedures similar to those of Example 1. The mixing ratio (A/B) of a tetraethoxysilane (A) and dimethyldimethoxysilane (B) in the oxygen enrichment layer-forming alkoxide solution of Example 2, as expressed in a molar ratio, is 7/3. The step of coating for the middle layer was performed two times, and the step of coating for the oxygen enrichment layer was performed two times, using production procedures and production conditions similar to those of Example 1, to produce the final oxygen enrichment membrane of Example 2. In the oxygen enrichment membrane of Example 2, the middle layer had a weight of 2.45 mg/cm², and the oxygen enrichment layer had a weight of 0.83 mg/cm². It was verified that the oxygen enrichment membrane of Example 2 has good ease of membrane formation and sufficient rigidity for practical use.

### Example 3

A middle layer-forming alkoxide solution (first mixture solution) and an oxygen enrichment layer-forming alkoxide solution (second mixture solution) were prepared, and were applied to a columnar object of an alumina ceramic having a monolith structure that is an inorganic porous support member, followed by a thermal treatment, to produce an oxygen enrichment membrane of Example 3 including a middle layer and an oxygen enrichment layer.

According to materials and their amounts shown in Table 1, a mixture solution of water, nitric acid, and ethanol was stirred for 30 min, and then a tetraethoxysilane was added to the mixture solution, followed by stirring for 2 h, to formulate a middle layer-forming alkoxide solution (first mixture solution). Also, according to materials and their amounts shown in Table 1, a mixture solution of water, nitric acid, and ethanol was stirred for 30 min, and then a tetraethoxysilane was added to the mixture solution, followed by stirring for 1 h, and then dimethyldimethoxysilane was added to the mixture solution, followed by stirring for 2.5 h, and then magnesium nitrate hexahydrate was added to the mixture solution, followed by stirring for 2 h, to formulate an oxygen enrichment layer-forming alkoxide solution (second mixture solution). The mixing ratio (A/B) of the tetraethoxysilane (A) and the dimethyldimethoxysilane (B) in the oxygen enrichment layer-forming alkoxide solution of Example 3, as expressed in a molar ratio, is 9/1. The step of coating for the middle layer was performed two times, and the step of coating for the oxygen enrichment layer was performed two times, using production procedures and production conditions similar to those of Example 1, to produce the final oxygen enrichment membrane of Example 3. In the oxygen enrichment membrane of Example 3, the middle layer had a weight of 2.14 mg/cm², and the oxygen enrichment layer had a weight of 0.94 mg/cm². It was verified that the oxygen enrichment membrane of Example 3 has good ease of membrane formation and sufficient rigidity for practical use.

### Example 4

A middle layer-forming alkoxide solution (first mixture solution) and an oxygen enrichment layer-forming alkoxide solution (second mixture solution) were prepared, and were applied to a columnar object of an alumina ceramic having a monolith structure that is an inorganic porous support member, followed by a thermal treatment, to produce an oxygen enrichment membrane of Example 4 including a middle layer and an oxygen enrichment layer.

According to materials and their amounts shown in Table 1, a middle layer-forming alkoxide solution and an oxygen enrichment layer-forming alkoxide solution that were used in Example 4 were formulated using procedures similar to those of Example 1. The mixing ratio (A/B) of a tetraethoxysilane (A) and dimethyldimethoxysilane (B) in the oxygen enrichment layer-forming alkoxide solution of Example 4, as expressed in a molar ratio, is 1/9. The step of coating for the middle layer was performed two times, and the step of coating for the oxygen enrichment layer was performed two times, using production procedures and production conditions similar to those of Example 1, to produce the final oxygen enrichment membrane of Example 4. In the oxygen enrichment membrane of Example 4, the middle layer had a weight of 2.24 mg/cm², and the oxygen enrichment layer had a weight of 1.12 mg/cm². It was verified that the oxygen enrichment membrane of Example 4 has good ease of membrane formation and sufficient rigidity for practical use.

### Example 5

A middle layer-forming alkoxide solution (first mixture solution) and an oxygen enrichment layer-forming alkoxide solution (second mixture solution) were prepared, and were applied to a columnar object of an alumina ceramic having a monolith structure that is an inorganic porous support member, followed by a thermal treatment, to produce an oxygen enrichment membrane of Example 5 including a middle layer and an oxygen enrichment layer.

According to materials and their amounts shown in Table 1, a middle layer-forming alkoxide solution and an oxygen enrichment layer-forming alkoxide solution that were used in Example 5 were formulated using procedures similar to those of Example 1. The mixing ratio (A/B) of a tetraethoxysilane (A) and dimethyldimethoxysilane (B) in the oxygen enrichment layer-forming alkoxide solution of Example 5, as expressed in a molar ratio, is 3/7. The step of coating for the middle layer was performed two times, and the step of coating for the oxygen enrichment layer was performed two times, using production procedures and production conditions similar to those of Example 1, to produce the final oxygen enrichment membrane of Example 5. In the oxygen enrichment membrane of Example 5, the middle layer had a weight of 2.31 mg/cm², and the oxygen enrichment layer had a weight of 1.01 mg/cm². It was verified that the oxygen enrichment membrane of Example 5 has good ease of membrane formation and sufficient rigidity for practical use.

### Example 6

An oxygen enrichment layer-forming alkoxide solution (second mixture solution) was prepared, and was applied to a columnar object of an alumina ceramic having a monolith structure that is an inorganic porous support member, followed by a thermal treatment, to produce an oxygen enrichment membrane of Example 6 including an oxygen enrichment layer.

According to materials and their amounts shown in Table 1, a mixture solution of water, nitric acid, and ethanol was stirred for 30 min, and then a tetraethoxysilane was added to the mixture solution, followed by stirring for 1 h, and then dimethyldimethoxysilane was added to the mixture solution, followed by stirring for 2.5 h, and then magnesium nitrate hexahydrate was added to the mixture solution, followed by stirring for 2 h, to formulate an oxygen enrichment layer-forming alkoxide solution (second mixture solution). The mixing ratio (A/B) of the tetraethoxysilane (A) and the dimethyldimethoxysilane (B) in the oxygen enrichment layer-forming alkoxide solution of Example 6, as expressed in a molar ratio, is 7/3. The step of coating for the oxygen enrichment layer was performed two times using a production procedure and production conditions similar to those of Example 1 to produce the final oxygen enrichment membrane of Example 6. In the oxygen enrichment membrane of Example 6, the oxygen enrichment layer had a weight of 3.75 mg/cm². It was verified that the oxygen enrichment membrane of Example 6 has good ease of membrane formation and sufficient rigidity for practical use.

### Example 7

A middle layer-forming alkoxide solution (first mixture solution) and an oxygen enrichment layer-forming alkoxide solution (second mixture solution) were prepared, and were applied to a columnar object of an alumina ceramic having a monolith structure that is an inorganic porous support member, followed by a thermal treatment, to produce an oxygen enrichment membrane of Example 7 including a middle layer and an oxygen enrichment layer.

According to materials and their amounts shown in Table 1, a mixture solution of water (first portion), nitric acid, and ethanol was stirred for 30 min, then a tetraethoxysilane and water (second portion) were added to the mixture solution, followed by stirring for 2 h, and then methyltriethoxysilane was added to the mixture solution, followed by stirring for 2.5 h, to formulate a middle layer-forming alkoxide solution (first mixture solution). Also, according to materials and their amounts shown in Table 1, a mixture solution of water, nitric acid, and ethanol was stirred for 30 min, then a tetraethoxysilane was added to the mixture solution, followed by stirring for 1 h, and then dimethyldimethoxysilane was added to the mixture solution, followed by stirring for 2.5 h, to formulate an oxygen enrichment layer-forming alkoxide solution (second mixture solution). In the oxygen enrichment layer-forming alkoxide solution of Example 7, the mixing ratio (A/B) of the tetraethoxysilane (A) and the dimethyldimethoxysilane (B), as expressed in a molar ratio, is 7/3. The step of coating for the middle layer was performed two times, and the step of coating for the oxygen enrichment layer was performed two times, using production procedures and production conditions similar to those of Example 1, to produce the final oxygen enrichment membrane of Example 7. In the oxygen enrichment membrane of Example 7, the middle layer had a weight of 2.34 mg/cm², and the oxygen enrichment layer had a weight of 1.01 mg/cm². It was verified that the oxygen enrichment membrane of Example 7 has good ease of membrane formation and sufficient rigidity for practical use.

### Comparative Example 1

A middle layer-forming alkoxide solution (first mixture solution) and an oxygen enrichment layer-forming alkoxide solution (second mixture solution) were prepared, and were applied to a columnar object of an alumina ceramic having a monolith structure that is an inorganic porous support member, followed by a thermal treatment, to produce an oxygen enrichment membrane of Comparative Example 1 including a middle layer and an oxygen enrichment layer.

According to materials and their amounts shown in Table 1, a mixture solution of water (first portion), nitric acid, and ethanol was stirred for 30 min, then a tetraethoxysilane and water (second portion) were added to the mixture solution, followed by stirring for 2 h, and then methyltriethoxysilane was added to the mixture solution, followed by stirring for 2.5 h, to formulate a middle layer-forming alkoxide solution (first mixture solution). Also, according to materials and their amounts shown in Table 1, a mixture solution of water, nitric acid, and ethanol was stirred for 30 min, then dimethyldimethoxysilane was added to the mixture solution, followed by stirring for 2.5 h, and then magnesium nitrate hexahydrate was added to the mixture solution, followed by stirring for 2 h, to formulate an oxygen enrichment layer-forming alkoxide solution (second mixture solution). Thus, only dimethyldimethoxysilane was added as an alkoxide to the oxygen enrichment layer-forming alkoxide solution of Comparative Example 1. The step of coating for the middle layer was performed two times, and the step of coating for the oxygen enrichment layer was performed two times, using production procedures and production conditions similar to those of Example 1, to produce the final oxygen enrichment membrane of Comparative Example 1. In the oxygen enrichment membrane of Comparative Example 1, the middle layer had a weight of 2.34 mg/cm², and the oxygen enrichment layer had a weight of 0.89 mg/cm². The oxygen enrichment membrane of Comparative Example 1 had less ease of membrane formation and insufficient rigidity for practical use because of the lack of a tetraethoxysilane in the oxygen enrichment layer.

<Oxygen Enrichment Performance Verification Test>

A test for verifying the oxygen enrichment performance of the oxygen enrichment membranes of Examples 1-7 and Comparative Example 1 was conducted. In this verification test, air (oxygen concentration: 20.7%) was caused to pass through the oxygen enrichment membrane, and the oxygen concentration of the gas after the passing was measured.

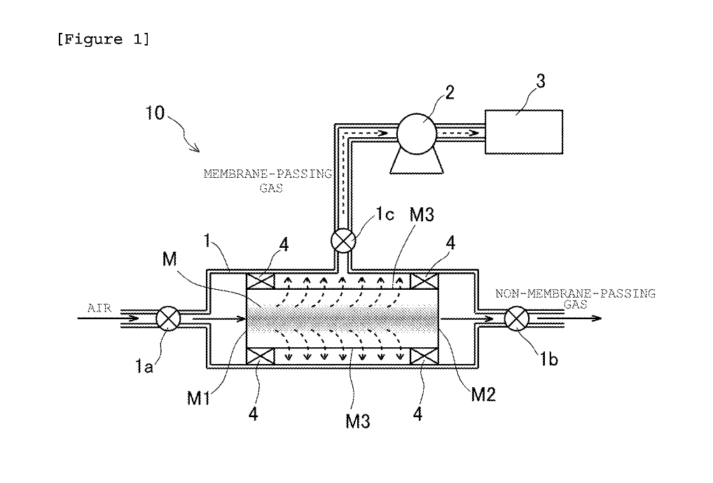

FIG. 1 is a schematic diagram of a configuration of an oxygen concentration measuring apparatus 10 used in the oxygen enrichment performance verification test. The oxygen concentration measuring apparatus 10 includes a chamber 1, a vacuum pump 2, and an oxygen concentration measuring instrument 3. The chamber 1, which has a hollow pipe-shaped structure, includes a first valve 1a and a second valve 1b provided on respective opposite ends thereof, and a third valve 1c provided on a side portion thereof. Oxygen enrichment membranes M to be tested are a columnar object including a middle layer and an oxygen enrichment layer that are formed on a surface (inner surface) of a porous internal structure of an alumina ceramic support member having a monolith structure (Examples 1-5 and 7 and Comparative Example 1), and a columnar object including an oxygen enrichment layer that is formed on a surface (inner surface) of a porous internal structure of an alumina ceramic support member having a monolith structure (Example 6). The Oxygen enrichment membrane M is provided in a hollow portion of the chamber 1 between the first valve 1a and the second valve 1b. The oxygen enrichment membrane M has a first end M1 connected to the first valve 1a, and a second end M2 connected to the second valve 1b, where gas is caused to enter from the first end M1 and exit from the second end M2. The oxygen enrichment membrane M also has a side surface M3 (the air permeable outer surface of the alumina ceramic support member) that is provided at a position that allows the side surface M3 to be in communication with the third valve 1c. The oxygen enrichment membrane M is hermetically held in the chamber 1 by a seal 4 so that the first valve 1a and the second valve 1b are spatially separated from the third valve 1c by the oxygen enrichment membrane M.

During the oxygen enrichment performance verification test, the first valve 1a and the third valve 1c of the chamber 1 are opened and the vacuum pump 2 is driven for suctioning. The ultimate pressure of the vacuum pump 2 is 200 Pa. As a result, external air enters the inside of the oxygen enrichment membrane M provided in the chamber 1 from the first valve 1a. A portion of the air entering the oxygen enrichment membrane M from the inner surface thereof and passing through the side surface M3 is drained from the third valve 1c, and is suctioned by the vacuum pump 2. The oxygen concentration of the gas drained from the third valve 1c (i.e., membrane-passing gas that has passed through the oxygen enrichment layer) is measured using the oxygen concentration measuring instrument 3. The opening degree of the second valve 1b of the chamber 1 is adjusted so that the gas flow rate is about 30 cc/min. As a result, gas that has not passed through the oxygen enrichment membrane M (i.e., non-membrane-passing gas that has not passed through the oxygen enrichment layer) is drained out from the second valve 1b. The result of the oxygen enrichment performance verification test is shown in Table 2.

TABLE 2

| | | | | | | | | Comparative |
|---|---|---|---|---|---|---|---|---|
| | Examples | | | | | | | Example |
| | 1 | 2 | 3 | 4 | 5 | 6 | 7 | 1 |
| Oxygen concentration after | 31.2 | 24.8 | 32.5 | 22.1 | 23.8 | 29.7 | 30.1 | 21.2 |
| passing through oxygen | | | | | | | | |
| enrichment membrane (%) | | | | | | | | |
| Flow rate of gas passing | 117 | 168 | 220 | 483 | 256 | 22 | 45 | 1024 |
| through oxygen enrichment | | | | | | | | |
| membrane (cc/min) | | | | | | | | |

As shown in Table 2, it was found that gas passed through the oxygen enrichment membranes (oxygen enrichment layers) of Examples 1-7 has a higher oxygen concentration than that of air, which allows for selective separation of oxygen. In particular, for the oxygen enrichment membranes of Examples 1-3, gas passed therethrough has a high oxygen concentration, and the rate at which gas passes therethrough has at least a predetermined value, and the oxygen enrichment performance and the gas processing rate are well balanced. Also, the oxygen enrichment membranes of Examples 4 and 5 have slightly less oxygen enrichment performance than that of Examples 1-3, but can have a higher gas processing rate. In particular, the gas processing rate of the oxygen enrichment membrane of Example 4 is about 2.2-4.1 times as high as those of the oxygen enrichment membranes of Examples 1-3. Therefore, for example, if a two-stage arrangement is provided in which the oxygen enrichment membrane of Example 4 or 5 is provided at the first stage (upstream stage), and the oxygen enrichment membrane of any of Examples 1-3 is provided at the second stage (downstream stage), the oxygen enrichment performance can be improved. The oxygen enrichment membranes of Examples 6 and 7 have oxygen enrichment performance similar to that of the oxygen enrichment membranes of Examples 1-3, but a slightly lower gas processing rate, which does not pose a problem with practical use. Meanwhile, the oxygen concentration of gas processed using the oxygen enrichment membrane of Comparative Example 1 remains almost unchanged from the oxygen concentration of air, i.e., the oxygen enrichment performance is not recognized.

Thus, it was found that the oxygen enrichment membrane of the present disclosure has good oxygen separation performance, and can provide a useful means for obtaining a high concentration of oxygen from air. Moreover, it was suggested that the oxygen enrichment membrane of the present disclosure has good physical membrane properties (mechanical strength, ease of membrane formation, etc.), and therefore, is industrially applicable.

The oxygen enrichment membrane of the present disclosure and the method for producing the oxygen enrichment membrane are applicable to the fields of industry, medicine, food, and the like.

What is claimed is:

1. An oxygen enrichment membrane comprising as a main component:
a hydrocarbon group-containing polysiloxane network structure material which is a reaction product of a tetraalkoxysilane and a hydrocarbon group-containing dialkoxysilane.

2. The oxygen enrichment membrane of claim 1, wherein
the tetraalkoxysilane is a tetramethoxysilane or a tetraethoxysilane (referred to as “A”), and
the hydrocarbon group-containing dialkoxysilane is dimethyldimethoxysilane or diethyldiethoxysilane (referred to as “B”).

3. The oxygen enrichment membrane of claim 2, wherein
the mixing ratio (A/B) of the A and the B as expressed in a molar ratio is 1/9-9/1.

4. The oxygen enrichment membrane of claim 1, wherein
the hydrocarbon group-containing polysiloxane network structure material additionally includes a metal salt having affinity for oxygen.

5. The oxygen enrichment membrane of claim 4, wherein
the metal salt is an acetate, nitrate, carbonate, borate, or phosphate of at least one metal selected from the group consisting of Li, Na, K, Mg, Ca, Ni, Fe, and Al.

6. The oxygen enrichment membrane of claim 1, wherein
the hydrocarbon group-containing polysiloxane network structure material is provided on a surface of an inorganic porous support member with a middle layer being interposed between the hydrocarbon group-containing polysiloxane network structure material and the surface of the inorganic porous support member.

7. The oxygen enrichment membrane of claim 6, wherein
the middle layer is a polysiloxane network structure material or hydrocarbon group-containing polysiloxane network structure material which is a sol-gel reaction product of an alkoxysilane or alkoxysilanes including a tetraalkoxysilane and/or a hydrocarbon group-containing trialkoxysilane.

8. A method for producing an oxygen enrichment membrane, comprising:
(a) a preparation step of formulating a first mixture solution which is a mixture of an alkoxysilane or alkoxysilanes including a tetraalkoxysilane and/or a hydrocarbon group-containing trialkoxysilane, an acid catalyst, water, and an organic solvent, and a second mixture solution which is a mixture of a tetraalkoxysilane, a hydrocarbon group-containing dialkoxysilane, an acid catalyst, water, and an organic solvent;
(b) a first application step of applying the first mixture solution to a surface of an inorganic porous support member;
(c) a middle layer formation step of thermally treating the inorganic porous support member after the end of the first application step, to form a middle layer including a polysiloxane network structure material on the surface of the inorganic porous support member;
(d) a second application step of applying the second mixture solution to the middle layer; and
(e) an oxygen enrichment layer formation step of thermally treating the inorganic porous support member after the end of the second application step, to form an oxygen enrichment layer including a hydrocarbon group-containing polysiloxane network structure material on the middle layer.

9. The method of claim 8, wherein
the preparation step includes additionally mixing a metal salt having affinity for oxygen into the second mixture solution.
